(19) United States
(12) Patent Application Publication
(10) Pub. No.: US 2010/0144878 A1
(43) Pub. Date: Jun. 10, 2010

(54) Nutritional supplement or functional food comprising oil combination

(76) Inventor: Michael A. Popp, Lauf/Pegnitz (DE)

Correspondence Address: REED SMITH LLP, 2500 ONE LIBERTY PLACE, 1650 MARKET STREET, PHILADELPHIA, PA, 19103, US

(21) Appl. No.: 11/919,472

(22) PCT Filed: Apr. 28, 2006
(86) PCT No.: PCT/EP2006/004021

§ 371 Date: Dec. 7, 2009

(30) Foreign Application Priority Data
Apr. 29, 2005 (EP) 05009471.3
Jan. 17, 2006 (EP) 06000920.6

(51) Int. Cl. A61K 31/202; A23D 9/00; A23L 1/30

(52) U.S. Cl. 514/560; 426/601; 426/72

(57) ABSTRACT

The present invention relates to a nutritional supplement or functional food comprising or consisting of (a) a nut oil in an amount of 0.5 to 20 percent by volume; (b) one or more ω-3-fatty acid sources in an amount of 10 to 50 or 10 to 90 percent by volume, the total amount of ω-3-fatty acids in each of the ω-3-fatty acid sources being at least 20 percent by volume; and (c) a flavour carrier in an amount of 10 to 89.5 percent by volume. Additionally the present invention relates to salad dressing consisting of or comprising the nutritional supplement or functional food of the invention. Finally the present invention relates to the use of the nutritional supplement or functional food of the invention as salad dressing.

The present invention relates to a food supplement or functional food comprising or consisting of (a) a nut oil in an amount of 0.5 to 20% vol.; (b) one or more sources containing ω-3-fatty acids in an amount of 10 to 50 or 10 to 90% vol., the total amount of ω-3-fatty acids in each of the sources containing ω-3 fatty acids being at least 20% vol.; and (c) a flavour carrier in an amount of 10 to 89.5% vol. Additionally the present invention relates to edible oil consisting of or comprising the food supplement or functional food of the invention. Finally the present invention relates to the use of the food supplement or functional food of the invention as edible oil.

Cardiovascular diseases are leading statistics on causes of death in Germany and Europe. This collective term covers various diseases such as heart attack, acute cardiac death and angina pectoris. In this context, it is often referred to the so-called coronary heart disease, abbreviated CHD. The common cause of all these wide-spread diseases often is arteriosclerosis developing unnoticed for many years. Gradually the blood vessels are constricted so that the blood can no longer flow in an unobstructed manner. Therefore, the blood circulation in the heart is no longer ideal. In the worst case, there is a sudden obstruction of the vessel, referred to as thrombosis, which leads to the blood and oxygen supply of the heart being interrupted totally. The consequence is a heart attack.

Numerous scientific studies have shown that false nutrition habits are one of the main causes for these risk factors. This means that by appropriate change of diet the occurrence of arteriosclerosis can be delayed or even avoided. In connection with diet, apart from vitamins, it is mainly the amount and manner of the fats absorbed which play an essential role for the development and progress of cardiovascular diseases. The right balance between saturated fatty acids of animal sources and unsaturated fatty acids from plants and fish becomes more and more important. The so-called ω-3 fatty acids and ω-6 fatty acids are of particular interest. ω-6 fatty acids are found in many vegetable oils and are therefore, with our present nutrition habits, consumed in sufficient amounts.

Linoleic acid, the most important representative of this family, is contained to a large degree, for example, in safflower, sunflower, soy, corn and wheat germ oil, but also in margarine. Multiple unsaturated fatty acids of type ω-3, however, are, at least in high concentrations, only contained in specific fatty fish and in algae.

ω-3 and ω-6 fatty acids are long-chain multiple unsaturated fatty acids. This means that they consist of at least 18 carbon atoms (C) and they have more than one double bond. The ω and n, respectively, represent the chain of the fatty acids being numbered starting from the methyl group. The number 3 and 6, respectively, refers to the position of the first double bond at the third and sixth carbonic atom, respectively. Since the human organism cannot produce either of the fatty acids from other fatty acids, the ω-3 and ω-6 fatty acid are considered essential. From these two fatty acids, the body can produce, in limited amounts, by means of the enzymes desaturase and elongase the longer-chain compounds, which it requires for various metabolism functions.

A great number of characteristics of the ω-3 fatty acids play a role as to the prophylactic effect against heart attack: studies with healthy and non-healthy individuals have shown that a great absorption of ω-3 fatty acids can reduce the triglyceride and cholesterol levels in the blood. A clear decrease of the fat level in the blood, however, only occurred with a relatively high intake of 3 to 4 gram per day. The ω-3 fatty acids reduce the unfavourable LDL cholesterol in particular. Moreover, scientists noticed that the blood of the Inuits clotted more slowly than the blood of Europeans. This is desirable for people at risk of heart attack, since it is often due to blood clots that the constricted vessels are blocked and thus cause a heart attack. ω-3 fatty acids have the effect that fewer substances promoting blood clotting are produced. At the same time, ω-3 fatty acids serve as a starting product for substances widening the vessels so that the clots cannot settle easily. When ω-3 fatty acids are increasingly introduced into the cell walls, the red blood cells are more flexible, which also promotes unrestricted blood flow. These properties also seem to have a favourable effect on blood pressure.

It has been known for years that fatty acids also have an effect on specific immune factors and inflammation processes. In clinical studies, their effect on chronic inflammatory diseases such as ulcerative colitis, Crohn's disease, rheumatism and mucoviscidosis is therefore examined. Unsaturated fatty acids are building blocks for tissue hormones influencing the course of inflammations. While hormones formed from ω-6 fatty acid are more likely to promote inflammations, prostaglandins and leukotrienes, which are produced from the ω-3 fatty acid EPA, are anti-inflammatory. Thus, it seems favourable for patients suffering from an inflammatory disease to take in an increased amount of ω-3 fatty acids.

With patients suffering from colon carcinoma, who took fish oil concentrates with two to seven gram ω-3 fatty acids a day, cancer cells divided more slowly than with a comparative group. A tumour-inhibitory effect could only be proven when the total amount of fatty acids in the food was no more than 30% of the energy supply. Thus, in addition to other measures, experts recommend to ensure a balanced ratio of ω-6 to ω-3 fatty acids and a low level of total fat supply.

Furthermore, a favourable effect of ω-3 fatty acids with rheumatoid arthritis is discussed in the literature (Rennie et al., “Nutritional management of rheumatoid arthritis: a review of the evidence”, J. Hum. Nutr. Dietet. 16 (2003), pages 97-109). In this context, reference is made to documentations showing a positive effect of long-chain n-3 poly unsaturated fatty acids on the symptoms. A diet is recommended which is rich in long-chain n-3 PUFA and anti-oxidants. Moreover, it is stated that no significant improvement was observed with other oils.

A further study deals with the effects of various oils on health, in particular on coronary diseases (Katan et al., “dietary oils, serum lipoproteins, and coronary heart disease”, Am. J. Clin. Nutr. 61 (1995), 1368-1373). In this context, Crete's inhabitants are mentioned as an example for people who on the basis of a high intake of olive oil as source of fat exhibited a low frequency of coronary diseases. This study also confirms that saturated fatty acids, in principle, increase LDL cholesterol and, thus, the susceptibility of heart diseases. In contrast, unsaturated fatty acids decrease the risk. It is further described that fish oils can increase LDL and apoprotein B in the blood, whereas the same holds for fatty fish. Fish oils and fatty fish, however, have favourable effects on the serum triglycerides and very low density lipoprotein. Despite this, it is considered fact that fish oils in populations taking in great amounts of fish oil decrease the frequency of coronary diseases.

A further publication discusses the effectiveness of vegetable and marine ω-3 fatty acids in the prevention and treatment of various diseases such as cardiovascular diseases and stroke (Kris-Etherton et al., “Fish Consumption, Fish Oil, ω-3 Fatty Acids and Cardiovascular Disease”, Circulation 106 (2002), p. 2747-2757). Essentially, large-scale studies are discussed, which predominantly confirm that these fatty acids have a positive/preventive effect on the course/breakout of a disease. However, with some studies, no effectiveness has been determined. Whereas fish oil and fatty fish are mentioned as the main sources for marine ω-3 fatty acids (in particular EPA and DHA), with the vegetable products olive oil, rape seed oil, walnut oil and linseed oil are mentioned, which contain concentrations of a lower level.

Darlington et al. (“Antioxidantien and fatty acids in the amelioration of rheumatoid arthritis and related disorders”, British Journal of Nutrition, 85 (2001), 251-269) discuss the possibilities of treating RA and similar diseases such as Lupus erythromatosis. Despite the authors pointing out the fact that available studies are not 100% significant due to experimental conditions, it is nevertheless clear that ω-3 fatty acids have a positive effect on the disease. In connection with administration of fish oil it is explained that the fish oil is given together with an antioxidant. Furthermore it is shown that the joint administration of EPA and DHA is more effective than the administration of one of said unsaturated fatty acids alone. Finally, the authors report that a marine extract of Perna canaliculus, which was rich with biologically active oils and natural antioxidants, shows also a protective effect in addition to a therapeutic effect as to inflammatory arthritis in rats.

Altogether it can be seen that in certain live situations, or also in general, an increased uptake of ω-3 fatty acids would be desirable. Particularly favourable sources of ω-3 fatty acids are algae and specific types of fish. In the state of the art it is however known that the uptake of ω-3 fatty acids is associated with experiencing an unpleasant taste of fish.

For this reason, the formulation of the ω-3 fatty acids in form of capsules is still of pertinent importance at the moment, since with this type of uptake of the ω-3 fatty acids, the unpleasant smell is often hardly noticeable, even if it cannot be avoided when belching. Use, for example, in form of edible oil with a high percentage of ω-3 fatty acids, however, is out of question for the reasons mentioned.

It can be seen that with many ω-3 fatty acids containing products available on the market, such as e.g. oils or oil mixtures, a sufficient supply with ω-3 fatty acids is not guaranteed when used as edible or salad oil or that, with regard to taste, the ω-3 fatty acids containing products are not suitable for use in edible or salad oils. Also, the ratio of ω-6 fatty acids to ω-3 fatty acids is often not compatible with recommendations of nutrition authorities. Furthermore, specific ω-3 fatty acids containing oil mixtures available on the market have particular storage requirements. Storage has to take place at low temperature, with storability still being limited (with regard to all points mentioned here compare, for example, the explanations on page 5 in the patent application GB-A 2392448 concerning a product called Primevere).

Thus, the task underlying the invention is the provision of a food supplement or functional food which solves the problems discussed above or which can be used as a basis for an edible oil or a salad oil or which can be used as an edible oil or a salad oil.

The problem is solved by the embodiments characterised in the claims.

Thus, the present invention relates to a food supplement or functional food comprising or consisting of (a) a nut oil in an amount of 0.5 to 20% vol.; (b) a source containing ω-3-fatty acids in an amount of 10 to 50% volume, wherein the total amount of ω-3-fatty acids is at least 20% vol.; and (c) a flavour carrier in an amount of 10 to 89.5% vol.

In general, “food supplements” are food stuffs containing one or more nutrients in concentrated form. In untypical food form, they usually comprise capsules, pastilles, tablets, liquids. Further typical forms of administration are powder sacs, liquid ampoules, bottles with drip inserts and similar administration forms of liquids and powders for the uptake in small amounts measured which are to supplement nutrition. According to the invention, a liquid/oily or spreadable consistency if preferred.

According to the invention, “functional food” summarises foodstuff and corresponding products lately developed to which importance is attributed not only due to them being valuable as to nutrition and taste but due to particular ingredient substances. According to the invention, the middle- or long-term maintenance and promotion of health are of importance. In this context, non-therapeutic uses are preferred. The terms nutriceuticals, foodsceuticals and designer foods, which also represent embodiments of the invention, are used as synonyms, partly, however, also in a differentiated way. The preventive aspect and the promotion of health as well as the food character of the products are, however, best made clear by the term functional food. In many cases, these relate to products accumulated by assortment and selection (as is also the case in the present invention), purification, concentration, increasingly also by addition. Isolated effective substances, in particular in form of tablets or pills, are not included.

The term “ω-3 fatty acids” (omega-3 fatty acids) refers to a fatty acid family important for humans, which characterises a specific metabolic pathway or several metabolic pathways. “Omega-3” means that the last double bond in the mostly poly unsaturated carbon chain of the fatty acid is—starting from the carboxylic group—at the last but two C—C bond. These include e.g. linolenic acid, eicosapentaenoic acid (EPA) and docosahexaenoic acid (docosahexaen acid; DHA). According to present knowledge, in this context, linolenic acid essentially plays the role of a precursor from which the human body can, to a certain extent, produce the longer-chain ω-3 fatty acids relevant for health, such as EPA and DHA. In this context, the term “longer-chain” refers to fatty acids with 20 or 22 carbon atoms, respectively. The ω-3 fatty acids can be added in form of an oil or be derived from another source. In any case it is to be made sure that the total amount of ω-3 fatty acids is at least 20% vol., e.g. at least 30% vol. or at least 40% vol. These figures refer to the ω-3 fatty acids content of the source containing ω-3 fatty acids according to the invention. This is an essential feature of the ω-3 fatty acids containing sources according to the invention which differ from other products, for example oils which do contain ω-3 fatty acids, however in a concentration below 20% vol. ω-3 fatty acids containing sources according to the invention may contain a mixture of any ω-3 fatty acids. Also, one (or more) specific ω-3 fatty acid(s) may become predominant, whereas others are present in traces only.

The term “the total amount of ω-3-fatty acids being at least 20% vol.” relates to the percentage by volume of ω-3 fatty acids in the component (b). In other words, the present invention relates to a food supplement or functional food comprising or consisting of (a) a nut oil in an amount of 0.5 to 20% vol.; (b) a source containing ω-3-fatty acids in an amount of 10 to 50% volume, the total amount of ω-3-fatty acids in the source containing ω-3 fatty acids being at least 20% vol.; and (c) a flavour carrier in an amount of 10 to 89.5% vol. ω-3 fatty acids containing sources according to the invention can contain 20, 30, 40, 50, 60, 70, 80 or 90% vol. ω-3 fatty acids in reference to the source. In certain cases they can also consist of ω-3 fatty acids exclusively. If the proportion of component (b) in the nutritional food or functional food is low, e.g. 10% vol., it is preferred that the proportion of ω-3 fatty acids in component (b) rises to a high level, for example 40, 50, 60 or more than 60% vol. If, however, the proportion of component (b) in the food supplement or functional food is relatively high and is e.g. at 50% vol., the proportion of ω-3 fatty acids in component (b) may be lower, e.g. at 20% vol.

Any values in %, if not stated otherwise, refer to percent by volume (% vol.). The percentage by volume of a component is the hundredfold amount of the quotient (volume of the component) divided by (volume of the food supplement or functional food according to the invention). Due to the similar density of the oils observed, the mass percentage has a similar value as the corresponding volume percentage.

Generally, the term “flavour carrier” refers to a substance which influences the experienced taste of a foodstuff to a significant degree or which contributes to the taste character of the foodstuff to a significant degree.

The above-mentioned percentage values add up to 100%, if the food supplement or functional food consists of the components. It is preferred that the maximum amount of the source containing ω-3 fatty acids or the total amount of sources containing ω-3 fatty acids is 45% as well as 40% or 35%.

From epidemiologic studies it is known that approx. 0.2 to 0.5 g of ω-3 fatty acids per day have favourable effects. Thus, according to present knowledge, approximately 0.5 g fish oil (containing 30% ω-3 fatty acids) should suffice, whereas with heart diseases or inflammatory diseases (e.g. rheumatism, psoriasis, etc.) this dose can be increased to approx. 1.5 to 2.5 g per day (approx. 20 g per week).

The product Omacor® approved by the FDA contains, per gram, approximately 465 mg EPA and approximately 375 mg DHA, i.e. a proportion of ω-3 fatty acids of approximately 840 mg per g of the product. The recommended daily dose is 4 g Omacor®, which corresponds to approximately 3.36 g ω-3 fatty acids. In the following, this dose is compared to the EPA and DHA amount absorbed, if the food supplement or functional food according to the invention is used, for example, for the preparation of a salad. For the purpose of exemplarily comparing the food supplement or functional food according to the invention with Omacor®, it is to be assumed that the food supplement or functional food is used as salad oil which is explicitly comprised in the present invention. In that case, e.g. 4 table spoons, corresponding to 50 g of the food supplement or functional food is used. The food supplement or functional food should contain 20% vol. salmon oil containing 30% vol. (based on the pure salmon oil) ω-3 fatty acids, i.e. EPA and DHA. Under these conditions (which are all subject matter of preferred embodiments; see below), 50 g salad oil according to the invention contains 3 g ω-3 fatty acids, i.e. EPA and DHA. If, furthermore, the food supplement according to the invention also contains perilla oil essentially supplying α-linolenic acid, the supply with EPA and DHA is even improved indirectly, since the human body is capable of producing EPA and DHA from α-linolenic acid to a certain degree. In summary, by preparing a salad a day with the food supplement or functional food according to the invention, an amount of ω-3 fatty acids is supplied which is comparable to or greater than the effective amount absorbed when taking the recommended daily dose of Omacor®.

The data provided in the ranges of Table 1 came about due to tasting trials. They confirm that the food supplement or functional food according to the invention, despite high concentrations of ω-3 fatty acids containing sources (up to 50% vol.), is not associated with a sense of fish odour experienced as unpleasant.

Thus, by means of the food supplement or functional food according to the invention, it is surprisingly achieved that by addition of nut oil, the “fishy” taste of the ω-3 fatty acid but not the taste of the vegetable oil is lost. In this way, the food supplement or functional food according to the invention, which, due to the considerable proportion of ω-3 fatty acids, is very valuable as to health, gets the flavour of a typical edible oil. In some embodiments, a nut oil (also) serves as flavour carrier, e.g. in cases where two nut oils are added (see Table 1).

The threshold where a “fishy” flavour in the combination according to the invention is at all experienced is, dependent on the individual, at a proportion of approximately 50% of the ω-3 fatty acids source in the food supplement or functional food. From a proportion of 60%, individual differences in sensing can no longer be determined in the sensory tests mentioned, i.e. in the combination of the components mentioned, the fishy flavour is also noticeable.

The formulation “containing food supplement or functional food” makes clear that instead of a ω-3 fatty acids containing source also two or more ω-3 fatty acids containing sources are explicitly considered as components of the food supplement or functional food according to the invention. Accordingly, the present invention also relates to a food supplement or functional food comprising or consisting of (a) a nut oil in an amount of 0.5 to 20% vol.; (b) two or more sources containing ω-3-fatty acids which together make up a proportion of 10 to 50% vol. of the nutritional supplement or functional food, the total amount of ω-3-fatty acids in each of the ω-3 fatty acid containing sources being at least 20% vol.; and (c) a flavour carrier in an amount of 10 to 89.5% vol.

Furthermore, the present invention relates to a food supplement or functional food comprising or consisting of (a) a nut oil in an amount of 0.5 to 20% vol.; (b) two or more sources containing ω-3-fatty acids, which together form a proportion of 10 to 90% vol. of the food supplement or functional food, wherein the total amount of ω-3-fatty acids in each of the ω-3 fatty acid containing sources is at least 20% vol.; and (c) a flavour carrier in an amount of 10 to 89.5% vol. In a preferred embodiment, the nut oil is selected from the group consisting of hazel nut, almond nut, walnut oil, pecan nut oil, paranut oil, cashew nut oil, pistachio oil, macadamia oil, pine oil. In this context, hazel nut oil, almond oil and walnut oil are particularly preferred. Furthermore, walnut oil is favourable due to a particularly advantageous ratio ω-6 fatty acids to ω-3 fatty acids. For walnut oil, this ratio has a value of 4. The term “ω-6 fatty acids” (omega-6 fatty acids) refers to a family of single or poly unsaturated fatty acids. “Omega-6” means that the last double bond in the mostly poly unsaturated carbon chain of the fatty acid is—starting from the carboxylic group—at the last but five C—C bond.

This embodiment according to the invention is based on the observation that the nut oils mentioned have been considered suitable, in tasting trials, to cover or suppress the “fishy” flavour of the ω-3 fatty acids containing sources.

In a further preferred embodiment, the proportion of nut oil in the food supplement or functional food according to the invention is between 2 and 10% vol. Any values between, such as for example 3, 4, 5, 6, 7, 8 and 9% vol. are explicitly comprised.

In another preferred embodiment, the ω-3 fatty acids containing source of the food supplement or functional food is an oil, such as a naturally-occurring oil.

In a further preferred embodiment, the two or more ω-3 fatty acids containing sources are two or more oils.

In a particularly preferred embodiment of the invention, the oil or the oils are selected from the group consisting of fish oil, algae oil, a ω-3 fatty acids containing vegetable oil or an oil produced from a mass of plankton, wherein, preferably, the mass of plankton essentially or exclusively consists of Crypthecodinium cohnii. Here, the term “essentially” refers to the fact that preferably at least 50%, more preferably at least 75%, even more preferably at least 90% and most preferably 99% of the mass of plankton consists of organisms of the species Crypthecodinium cohnii. Fish oils from cold water fish rich in fat, such as herring, tuna, mackerel or salmon are preferably obtained, they are, however, also obtainable from sardines, trout, halibut, codfish, haddock, sheatfish, flounder and other fish according to common methods. The production of ω-3 fatty acids from algae or algae oil is further preferred. Preferred algae include, for example, microalgae, in particular of the families of the brown, red, green or blue green algae. Amongst those, the algae from the family of the Phaeoophyceae or Rhodophyceae are particularly preferred. Aphanizomenon flos-aquae (AFA algae), spirulina are further preferred, wherein the microalgae Ulkenia sp. and Schizochytrium are particularly preferred.

It is particularly preferred that the food supplement or functional food according to the invention contains two (and no more) ω-3 fatty acids containing sources. In particular, it is preferred that one of the two sources is a fish oil and the other one is a ω-3 fatty acids containing vegetable oil.

In the embodiments wherein (i) the proportion of ω-3 fatty acids containing sources in the food supplement or functional food is more than 50% vol. and (ii) one of the ω-3 fatty acids containing sources is a fish oil, it is preferred that the proportion of the fish oil in the food supplement or functional food is not more than 50% vol. In this way it has been accounted for the fact that a proportion of more than 50% vol. fish oil can lead to the perception of a fishy taste, which is undesired according to the invention.

A particularly preferred fish oil is salmon oil. Salmon oil can be obtained, for example in pharmaceutical quality, from the company Henry Lamotte in Bremen. Said salmon oil is obtained from the bodies of sea salmons and at least 60% is derived from the classic atlantic salmon Salmo salar, the other parts are derived from other sea salmons and trouts of the Oncorhynches family. Preferably salmon oil contains 23 to 34% ω-3 fatty acids, with 9 to 14% being eicosapentaenoic acid (EPA) and 8 to 12% being docosahexaenoic acid (DHA). At a temperature of 20° C., the salmon oil from the above-mentioned source has a density of 0.920 to 0.935 kg/dm³.

A preferred ω-3 fatty acids containing vegetable oil is perilla oil. Perilla oil can be obtained, for example, from Henry Lamotte in Bremen. It is produced from the seed of the labiate flower Perilla (Perilla ocymoides L.), which is close to the lavender species and the spice plant basil, by expelling/purification. Preferably, perilla oil contains 45-64% linolenic acid. It is also preferred that perilla oil contains 5-10% palmitic acid, 1-5% stearic acid, 12-25% oleic acid and 10-20% linoleic acid. At a temperature of 20° C., the perilla oil from the above-mentioned source has a density of 0.925-0.931 kg/dm³.

A further preferred ω-3 fatty acids containing vegetable oil is argan oil. Argan oil is produced from the stones of the argan fruit, the fruit of the ironwood or argan tree. Argan oil has a nutty smell and taste. This is why, apart from using it for the provision of ω-3 fatty acids, it can be used for masking the fish taste caused by fish oil possibly present.

In a particularly preferred food supplement or functional food according to the invention, the two ω-3 fatty acids containing sources are present in the same concentration, preferably 20% vol. each. If the food supplement or functional food according to the invention contains 20% vol. salmon oil and 20% vol. perilla oil, the ω-3 fatty acids content of the combined ω-3 fatty acids containing sources is preferably between 34% vol. and 49% vol., depending on the quality of the salmon oil and the perilla oil (arithmetic mean of the above-mentioned lower limit 23% for salmon oil and 45% for perilla oil, and arithmetic means of the above-mentioned upper limit 34% for salmon oil and 64% for perilla oil, respectively). Any values between, such as e.g. 40% vol., 45% vol., 50% vol., 55% vol. and 60% vol. ω-3 fatty acids content of the two combined ω-3 fatty acids containing sources are explicitly comprised. Thus, the ω-3 fatty acids content of the food supplement or functional food according to the invention, which is mediated by the ω-3 fatty acids containing sources, should preferably lie between approximately 13% vol. and approximately 20% vol. (40% of ω-3 fatty acids content of the two combined ω-3 fatty acids containing sources). Any values between, such as 14% vol., 15% vol., 16% vol., 17% vol., 18% vol. and 19% vol. are explicitly comprised. If other relative amounts of the ω-3 fatty acids containing sources according to the invention are used, the ω-3 fatty acids content of the food supplement or functional food according to the invention, which is mediated by the ω-3 fatty acids containing sources, may lie outside the value range from approximately 13% vol. to approximately 20% vol. Similarly this applies for the total ω-3 fatty acids content of the food supplement or functional food according to the invention, since the other components (nut oil and flavour carrier) also may contain ω-3 fatty acids, even though in a significantly lower concentration than the ω-3 fatty acids containing sources according to the invention.

Food supplements or functional food with the two ω-3 fatty acids containing sources being present in different concentrations are explicitly comprised. For example, the food supplement or functional food according to the invention may comprise 30% vol. fish oil and 40% vol. perilla oil.

In a further preferred embodiment of the invention, the ω-3 fatty acids of the source or of the sources are linolenic acid (α-linolenic acid), eicosapentaenoic acid and/or docosahexaenoic acid, wherein the cis-9,12,15-octadecatrienoic acid, cis-5,8,11,14,17-eicosapentaenoic acid and cis-4,7,10,13,16,19-docosahexaenoic acid are particularly preferred.

In a further preferred embodiment of the invention, the flavour carrier is a vegetable oil. Due to the flavour carrier significantly contributing to the taste character of the foodstuff, the selection of the flavour carrier is of particular importance for the production of the foodstuff. In particularly preferred embodiments, the flavour carrier may also be a nut oil. In this embodiment, the foodstuff will exhibit the nutty character of the flavour carrier essentially due to the proportion of nut oils.

In a particularly preferred embodiment, the vegetable oil is olive oil, rape seed oil, linseed oil, soy oil, wheat germ oil, hazelnut oil, walnut oil or almond oil. In these cases, the plant oils used as flavour carriers will significantly mould the taste character of the foodstuff. For a long time, rape seed oil was considered a risk to health due to the relatively high eruca acid content. Due to new breedings, in particular in Canada and Western Europe, it was possible to reduce the eruca acid content of the oil to less than 1%. Accordingly, the food supplement or functional food according to the invention should contain an amount of eruca acid which is as small as possible, preferably in the range of less than 1%.

In a further preferred embodiment, the flavour carrier exhibits a low ratio of ω-6 fatty acids to ω-3 fatty acids. The ratio of ω-6 fatty acids to ω-3 fatty acids being 4 is particularly preferred. It is to be mentioned that, with a conventional diet, the average ratio of ω-6 fatty acids to ω-3 fatty acids is approximately 20. Depending on the source, the following flavour carriers according to the invention have the following ratios of ω-6 fatty acids to ω-3 fatty acids (the values of the ratios of ω-6 fatty acids to ω-3 fatty acids in brackets are approximate values which may vary within the boundaries typical for natural products): linseed (0.25), soy oil (7), wheat germ oil (7), olive oil (16), walnut oil (4) and rape seed oil (2). In comparison, olive oil shows a high ratio of ω-6 fatty acids to ω-3 fatty acids, it is, however, characterised by a content of ω-6 fatty acids to ω-3 fatty acids which is low in total.

In a further preferred embodiment, the flavour carrier makes up 30 to 60% vol. of the food supplement or functional food. Any % vol. values within this range are explicitly comprised, such as e.g. 35, 40, 45, 50 and 55% vol.

In a preferred embodiment, the food supplement or functional food according to the invention further contains an antioxidant: Antioxidants (Antioxidant) refer(s) to chemical compounds with different structures which are capable of preventing or reducing the oxidation of other substances (e.g. fatty acids) with oxygen compounds. They are naturally contained, among others e.g. in garlic, cabbage, broccoli, licorice, ginger, tea, carrot, parsley, onion, citrus fruit, tomato, rosemary, cucumber. In connection with the teaching of the invention, antioxidants must prevent the oxidation of ω-3 fatty acids in particular.

In a particularly preferred embodiment of the invention, the antioxidant is tocopherol (vitamin E, E 306) or an antioxidant selected from the group consisting of L-ascorbic acid (vitamin C, E 300), sodium-L-ascorbate (E 301), calcium-L-ascorbate (E 302), lactic acid (E 270), α-tocopherol (E 307), citric acid (E 330). The antioxidant tocopherol (vitamin E, E 306) is particularly preferred. According to the invention, combinations of these antioxidant are also possible. If an antioxidant is added, its amount is added to the other components essential to the invention, which, in this case, cannot add up to 100% any longer (but only to a value of under 100%). Preferred amounts of the antioxidant are in the range of under 1% vol., for example 0.2, 0.4, 0.5 or 0.7% vol.

Numerous artificial and natural antioxidants are known to the person skilled in the art which may be used in the food supplement or functional food according to the invention, with few exceptions. These include for example any antioxidants belonging to the vitamin E family and mainly contained in nuts and sunflower seeds. Often, they are also used in plant oils, margarine and cocoa products. Lycopine, a naturally occurring antioxidant, which belongs to the group of carotenoids and which is mainly contained in red tomatoes (about 20 mg/kg) is another example. Lycopine belongs to the strongest natural protection substances against oxidation. Studies have shown that lycopine may also serve as an effective substance for the reduction of the risk of certain types of cancer.

In a further preferred embodiment, the food supplement or functional food according to the invention is storable at room temperature.

Within the meaning of the invention, a food supplement or functional food consisting of approximately 2% vol. almond oil, approximately 20% vol. fish oil, preferably salmon oil, approximately 20% vol. perilla oil and approximately 0.4% vol. vitamin E is particularly preferred, wherein supplementation to 100% vol. is carried out with olive oil as flavour carrier.

Furthermore, the present invention relates to an edible oil and preferably a salad oil consisting of or containing the food supplement or functional food according to the invention.

The term “edible oil” refers to any preparation using the food supplement according to the invention or the functional food according to the invention which can be added to food as an oil. One example is the use of an edible oil as spread or sauce for white bread, e.g. with wine trials. Moreover, it can be used in many traditional dishes, e.g. in “Spaghetti aglio e olio”. Apart from the food supplement or functional food according to the invention, the edible oil may contain further taste components such as e.g. herbs.

Finally, the present invention relates to the use of the food supplement or functional food according to the invention as edible oil. In a preferred embodiment of the invention, the edible oil is a salad oil. Furthermore it is preferred that the use has a non-therapeutic character.

The present invention also relates to a pharmaceutical composition comprising or consisting of the food supplement according to the invention.

Moreover, the invention relates to the use of the food supplement according to the invention for the preparation of a pharmaceutical composition for the prophylaxis or treatment of cardiovascular diseases, inflammatory diseases and tumours.

The present invention also relates to a method for the prophylaxis or treatment of cardiovascular diseases, inflammatory diseases and tumours, comprising the administration of a therapeutically effective amount of the food supplement according to the invention.

The cardiovascular diseases mentioned comprise heart attack, acute cardiac death, angina pectoris as well as calcification of the blood vessels (arteriosclerosis) and hypertension. Inflammatory diseases comprise chronic inflammatory diseases such as ulcerative colitis, Crohn's disease, rheumatism, mucoviscidosis, rheumatoid arthritis and Lupus erythromatosis. The tumours comprise tumours of the colon, in particular colon carcinoma as well as mammacarcinoma, prostate carcinoma and ovarian carcinoma.

Preferably, the food supplement or functional food according to the invention is produced in a method comprising the step or the steps of mixing at least one nut oil with at least one ω-3 fatty acids containing source, wherein the ω-3 fatty acids content in the ω-3 fatty acids containing source(s) is at least 20% vol., and at least one flavour carrier, wherein a final concentration of the nut oil of 0.5 to 20% vol, a final concentration of the ω-3 fatty acids containing source(s) of 10 to 90% vol. and a final concentration of the flavour carrier of 10 to 89.5% vol. is achieved. In this context, production methods are comprised during which all the components are added and mixed together in one step as well as production methods during which one or more components are added individually or consecutively in a receptacle or a basin and then each is mixed with the components already present in the receptacle or basin. Furthermore, this production method may comprise the addition of further components, for example the addition of an antioxidant.

The nut oil used in the food supplement or functional food according to the invention and in the method according to the invention is an oil produced by, for example, expelling nuts.

### THE EXAMPLES ILLUSTRATE THE INVENTION

The combinations shown in Tables 1 and 2 are advantageous embodiments of the invention. The numerical values represent values in percent by volume.

Table 1: Mixing ratios of the oil components of the food supplement or functional food according to the invention are shown, which did not have a “fishy” taste in a sensory examination of the corresponding food supplement or functional food.

| | | | | | | | | | fish oil, | |
|---|---|---|---|---|---|---|---|---|---|---|
| | | | | | | | | | other | |
| | | | | | | | | | sources | number |
| | | rape | | | wheat | hazel- | | | of ω-3 | of |
| | olive | seed | linseed | soy | germ | nut | walnut | almond | fatty | combination |
| serial | oil | oil | oil | oil | oil | oil | oil | oil | acids | partners |
| number | 1 | 2 | 3 | 4 | 5 | 6 | 7 | 8 | 9 | 10 |
| 1 | 10-89.5 | — | — | — | — | — | — | 0.5-20 | 10-50 | 3 |
| 2 | — | 10-89.5 | — | — | — | — | — | 0.5-20 | 10-50 | 3 |
| 3 | — | — | 10-89.5 | — | — | — | — | 0.5-20 | 10-50 | 3 |
| 4 | — | — | — | 10-89.5 | — | — | — | 0.5-20 | 10-50 | 3 |
| 5 | — | — | — | — | 10-89.5 | — | — | 0.5-20 | 10-50 | 3 |
| 6 | — | — | — | — | — | 10-89.5 | — | 0.5-20 | 10-50 | 3 |
| 7 | — | — | | | | — | 10-89.5 | 0.5-20 | 10-50 | 3 |
| 14 | | | | | | | 0.5-20 | 10-89.5 | 10-50 | |
| 8 | 10-89.5 | — | — | — | — | — | 0.5-20 | — | 10-50 | 3 |
| 9 | — | 10-89.5 | — | — | — | — | 0.5-20 | — | 10-50 | 3 |
| 10 | — | — | 10-89.5 | — | — | — | 0.5-20 | — | 10-50 | 3 |
| 11 | — | — | — | 10-89.5 | — | — | 0.5-20 | — | 10-50 | 3 |
| 12 | — | — | — | — | 10-89.5 | — | 0.5-20 | — | 10-50 | 3 |
| 13 | — | — | — | — | — | 10-89.5 | 0.5-20 | | 10-50 | 3 |
| 20 | — | — | — | — | — | 0.5-20 | 10-89.5 | — | 10-50 | 3 |
| 15 | 10-89.5 | — | — | — | — | 0.5-20 | — | — | 10-50 | 3 |
| 16 | — | 10-89.5 | — | — | — | 0.5-20 | — | — | 10-50 | 3 |
| 17 | — | — | 10-89.5 | — | — | 0.5-20 | — | — | 10-50 | 3 |
| 18 | — | — | — | 10-89.5 | — | 0.5-20 | — | — | 10-50 | 3 |
| 19 | — | — | — | — | 10-89.5 | 0.5-20 | — | — | 10-50 | 3 |

Table 2 (next page). Further preferred food supplements according to the invention. In the middle of the Table, combinations of fish oil/salmon oil of different qualities and perilla oil of different qualities are exemplified, with both the fish oil/salmon oil and the perilla oil being 20 percent by volume of the food supplement according to the invention each. In this context, the proportion of ω-3 fatty acids in the food supplement according to the invention is shown in percent by volume in the column “Total O3FA content”. In the column “total % value O3FA content of both O3FA sources”, the average content of ω-3 fatty acids in percent by volume of a mixture of equal parts of fish oil/salmon oil and perilla oil is shown.

| % vol. | | | | | | | | |
|---|---|---|---|---|---|---|---|---|
| | flavour | flavour | flavour | O3FA | O3FA | | | |
| antioxidant | carrier | oil | oil | source | source | | | |
| vitamin | olive | nut | almond | fish- | perilla | | | |
| E | oil | oil | oil | salmon oil | oil | total | | |
| | | | | 23-34 | 45-64 | | O3FA | |
| | | | | | | | content | |
| | | | | | | | range | |
| | 89.5 | 0.5 | | 10 | | 100 | | |
| 0.4 | 57.6 | | 2 | 20 | 20 | 100 | | |
| | | | | fish/salmon | perilla | | | |
| | | | | oil | oil | | | |
| | | | total | 20 | 20 | total | | |
| | | | amount | | | amount | | |
| | | | >> | | | << | | |
| | | | | | | | | total % |
| | | | | | | | | value |
| | | | | | | | | O3FA |
| | | | | | | | | content |
| | | | content | | | content | total | of both |
| | | | levels | O3FA | O3FA | levels | O3FA | O3FA |
| | | | (%) | content | content | (%) | content | sources |
| | | | 34 | 6.80 | 12.80 | 64 | 19.60 | 49.00 |
| | | | 30 | 6.00 | 12.20 | 61 | 18.20 | 45.50 |
| | | | 25 | 5.00 | 11.00 | 55 | 16.00 | 40.00 |
| | | | 24 | 4.80 | 10.00 | 50 | 14.80 | 37.00 |
| | | | 23 | 4.60 | 9.00 | 45 | 13.60 | 34.00 |
| | 79 | 1 | | 20 | | 100 | | |
| | 65 | 5 | | 30 | | 100 | | |
| | 50 | 10 | | 40 | | 100 | | |
| | 40 | 15 | | 45 | | 100 | | |
| | 30 | 20 | | 50 | | 100 | | |
| 0.4 | 20 | 19.6 | | 50 | 10 | 100 | | |
| 0.4 | 10 | 19.6 | | 50 | 20 | 100 | | |
| 0.4 | 10 | 9.6 | | 50 | 30 | 100 | | |
| 0.4 | 10 | 1 | | 50 | 38.6 | 100 | | |

1. Food supplement or functional food comprising or consisting of
(a) a nut oil in an amount of 0.5 to 20% vol.;
(b) a source containing ω-3 fatty acids in an amount of 10 to 50% vol., wherein the total amount of ω-3 fatty acids is at least 20% vol., and wherein the source containing ω-3 fatty acids is perilla oil or argan oil; and
(c) a flavour carrier in an amount of 10 to 89.5% vol.

2. Food supplement or functional food comprising or consisting of
(a) a nut oil in an amount of 0.5 to 20% vol.;
(b) two or more sources containing ω-3 fatty acids, which together form a portion of 10 to 50% vol. of the food supplement or functional food, wherein the total amount of ω-3 fatty acids in each of the sources containing ω-3 fatty acids is at least 20% vol., and wherein the two or more sources containing ω-3 fatty acids are two or more oils including the ω-3 fatty acids-containing vegetable oil(s) perilla oil and/or argan oil; and
(c) a flavour carrier in an amount of 10 to 89.5% vol.

3. Food supplement or functional food comprising or consisting of
(a) a nut oil in an amount of 0.5 to 20% vol.;
(b) two or more sources containing ω-3 fatty acids, which together form a portion of 10 to 90% vol. of the food supplement or functional food, wherein the total amount of ω-3 fatty acids in each of the sources containing ω-3 fatty acids is at least 20% vol., and wherein the two or more sources containing ω-3′ fatty acids are two or more oils including the ω-3 fatty acids-containing vegetable oil(s) perilla oil and/or argan oil; and
(c) a flavour carrier in an amount of 10 to 89.5% vol.

4. A food supplement or functional food according to any one of claims 1 to 3, wherein the nut oil is almond oil, hazelnut oil or walnut oil.

5. A food supplement or functional food according to any one of claims 2 to 4, wherein the oils are selected from the group consisting of fish oil, algae oil, a vegetable oil containing ω-3 fatty acids and an oil produced from plankton, wherein preferably the plankton essentially consists of Crypthecodinium cohnii.

6. A food supplement or functional food according to any one of claims 2 to 5, containing two sources containing ω-3 fatty acids.

7. The food supplement or functional food according to claim 6, wherein a source is a fish oil.

8. The food supplement or functional food according to claims 5 to 7, wherein the fish oil is salmon oil.

9. A food supplement or functional food according to any one of claims 6 to 8, wherein the two sources containing ω-3 fatty acids are present in the same concentration, preferably 20% vol. each.

10. A food supplement or functional food according to any one of claims 1 to 9, wherein the ω-3 fatty acids of the source or sources is/are α-linoleic acid, eicosapentaenoic acid and/or docosahexanoic acid.

11. A food supplement or functional food according to any one of claims 1 to 10, wherein the flavour carrier is a vegetable oil.

12. The food supplement or functional food according to claim 11, wherein the vegetable oil is olive oil, rape-seed oil, linseed oil soy bean oil, wheat germ oil, hazelnut oil, walnut oil or almond oil.

13. A food supplement or functional food according to any one of claims 1 to 12, further comprising
(d) an antioxidant.

14. The food supplement or functional food according to claim 13, wherein the antioxidant is vitamin E and/or vitamin C.

15. An edible oil consisting of or comprising the food supplement or functional food according to any one of claims 1 to 14.

16. The edible oil according to claim 15, which is a salad oil.

17. Use of the food supplement or functional food according to any one of claims 1 to 14 as edible oil.

18. Use according to claim 17, wherein the edible oil is a salad oil.

19. Method for the production of a food supplement or functional food, comprising the step or the steps of mixing at least one nut oil with at least one source containing ω-3 fatty acids, wherein the content of ω-3 fatty acids in the source(s) containing ω-3 fatty acids is at least 20% vol., and wherein at least one source containing ω-3 fatty acids is perilla oil or argan oil, and at least one flavour carrier, wherein a final concentration of 0.5 to 20% vol. of nut oil, a final concentration of 10 to 90% vol. of the source(s) containing ω-3 fatty acids and a final concentration of 10 to 89.5% vol. of the flavour carrier is reached.

20. The method according to claim 19, wherein further an antioxidant is added.

21. Pharmaceutical composition comprising or consisting of the food supplement according to any one of claims 1 to 14.

22. Use of the food supplement according to any one of claims 1 to 14 for the production of a pharmaceutical composition for the prophylaxis or treatment of cardiovascular diseases, inflammatory diseases and tumours.
